(19) United States
(12) Patent Application Publication
(10) Pub. No.: US 2026/0105594 A1
(43) Pub. Date: Apr. 16, 2026

(54) METHOD FOR DETECTING WEAR ON ULTRASONIC TOOLS

(71) Applicant: Hesse GmbH, Paderborn (DE)

(72) Inventors: Matthias HUNSTIG, Paderborn (DE); Michael BROEKELMANN, Delbrueck (DE); Waldemar SCHAERMANN, Schlangen (DE); Sebastian HOLTKAEMPER, Paderborn (DE)

(73) Assignee: Hesse GmbH, Paderborn (DE)

(21) Appl. No.: 19/391,044

(22) Filed: Nov. 17, 2025

Related U.S. Application Data
(63) Continuation of application No. PCT/DE2024/100429, filed on May 13, 2024.

(30) Foreign Application Priority Data
May 17, 2023 (DE) 10 2023 113 061.7

(51) Int. Cl. G06T 7/00; B23K 20/10; B23K 31/12

(52) U.S. Cl. CPC G06T 7/001; B23K 20/10; B23K 31/125; G06T 2207/20084; G06T 2207/30108

(57) ABSTRACT

A method for detecting wear on ultrasonic tools. A displaceable and/or rotatable ultrasonic tool of an ultrasonic joining machine is positioned relative to at least one camera such that a profiled work side of the ultrasonic tool is provided in a capture region of the at least one camera. The camera generates at least one high-resolution 2D image of the work side of the ultrasonic tool in a wear state. The high-resolution 2D image is compared with at least one reference image of the work side of the ultrasonic tool and an actual wear value for the ultrasonic tool is determined by way of image processing. The actual wear value of the ultrasonic tool is compared with a tool-specific limit wear value. If the actual wear value reaches or exceeds the limit wear value, then measures for changing or for maintenance of the ultrasonic tool are initiated.

This nonprovisional application is a continuation of International Application No. PCT/DE2024/100429, which was filed on May 13, 2024, and which claims priority to German Patent Application No. 10 2023 113 061.7, which was filed in Germany on May 17, 2023, and which are both herein incorporated by reference.

### BACKGROUND OF THE INVENTION

### Field of the Invention

The invention relates to a method for optical detection of wear on ultrasonic tools. Furthermore, the invention relates to the use of the method in the ultrasonic-assisted connecting of metallic connection partners, for example in ultrasonic wire bonding or in ultrasonic welding.

### Description of the Background Art

Ultrasonic tools that are used in ultrasonic wire bonding and in ultrasonic welding, for example, are subject to considerable resultant wear on account of the stresses they experience. In practice today, ultrasonic tools typically are replaced after a fixed number of welds. A safety margin is routinely taken into account in this case in order to ensure that the ultrasonic tool is always in sufficiently good condition and the joints are produced with high quality. It is customary, for example, to replace an ultrasonic tool that is nominally designed to produce 25,000 ultrasonic joints after approximately 20,000 joints as a precaution.

It is also known to sense the wear of an ultrasonic tool by measurement or to evaluate it in accordance with user-specific criteria such as the optical appearance ascertained by visual inspection or the strength of the joints, and to replace it if necessary.

Thus, EP 3 871 822 A1 describes a method for monitoring a wear state of an ultrasonic processing system in which a work surface of the ultrasonic tool is pressed against a test piece and subjected to a force in order to determine a wear state. The ultrasonic tool is then excited into ultrasonic vibrations. In the phase of vibration excitation, measurement parameters of electrical and/or mechanical quantities are captured and compared with previously stored reference parameters. Conclusions are drawn regarding the wear state of the ultrasonic tool from the comparison of the measurement parameters with the reference parameters.

It is known from WO 2017/079085 A1, which corresponds to US 2017/0120372, to ascertain the wear of an ultrasonic tool by evaluating an impression that the ultrasonic tool creates with its profiled work side on the connection partner when producing the joint. The way in which the impression of the ultrasonic tool on the connection partner changes provides information about the wear of the tool.

Eichwald describes a method in which the work side of the ultrasonic tool is measured using a laser-assisted 3D scan method (Paul Eichwald: Prozessgerechte Gestaltung von Werkzeugen auf Basis von Verschleisssimulationen am Beispiel des Ultraschallbondens [Process-oriented design of tools on the basis of wear simulations using the example of ultrasonic bonding], Shaker Verlag, 2021). The measured values are used to calculate a wear-induced volume loss at the work side of the ultrasonic tool and to determine the wear state.

A method for wear monitoring of ultrasonic tools is known from WO 2019/161902 A1 in which wear marks that are worked into the ultrasonic tool for the purpose of wear monitoring are captured optically. Conclusions about the wear of the ultrasonic tool can then be drawn from the change in the wear mark.

All of the methods for detecting wear on ultrasonic tools known up until now are relatively costly. They can barely be integrated cost-effectively in a production facility and/or they require the use of specific ultrasonic tools and/or expensive measuring instruments.

### SUMMARY OF THE INVENTION

It is therefore an object of the present invention to provide an improved and economical method for detecting wear on ultrasonic tools having a profiled work side.

Accordingly, in an example, a method is provided for detecting wear on ultrasonic tools that comprises the following method steps: a displaceable and/or rotatable ultrasonic tool of an ultrasonic joining machine is positioned relative to at least one camera of the ultrasonic joining machine such that a profiled work side of the ultrasonic tool and/or a profile of the work side are/is provided in a capture region of the at least one camera. Then at least one high-resolution 2D image of the profiled work side of the ultrasonic tool and/or of the profile of the work side in a wear state is recorded by the at least one camera. The at least one high-resolution 2D image of the profiled work side of the ultrasonic tool and/or of the profile of the work side in the wear state is then compared with at least one stored reference image of the profiled work side of the ultrasonic tool and/or of the profile of the work side, and an actual wear value for the ultrasonic tool is ascertained by way of image processing. The actual wear value of the ultrasonic tool thus ascertained is then compared with a tool-specific limit wear value. If the actual wear value reaches or passes or exceeds the limit wear value, then measures for changing or for maintenance of the ultrasonic tool are initiated. According to the invention, the wear value can be defined in this case such that it increases or decreases with increasing wear.

An advantage of the invention is that the wear of the ultrasonic tool can be captured or monitored in the ongoing manufacturing process by means of a 2D camera and a suitable image processing routine. The ultrasonic tool accordingly can be replaced or sent for maintenance according to need. A worn or faulty ultrasonic tool can be identified and exchanged in this way. At the same time, a preventative, premature replacement of the ultrasonic tool can be avoided. As described below, a substantial cost advantage and a gain in productivity arise as a result.

On the assumption that 25,000 ultrasonic joints, on average, can be produced with an ultrasonic tool and that, without suitable monitoring measures, the ultrasonic tool is replaced after 20,000 joints as a precaution, the advantage is achieved, calculated over 1,000,000 joints, that 40 instead of 50 ultrasonic tools are worn out. This corresponds to a materials cost reduction of 20%. Moreover, an additional time advantage arises when one assumes that the wear state of the ultrasonic tool is optically monitored with the method according to the invention after every 1,000 joints produced. The recording of the at least one high-resolution 2D image of the profiled work side of the ultrasonic tool will typically take approximately 5 seconds in this case. A changing of the ultrasonic tool including maintenance time and subsequent calibration typically takes 10 minutes. Here, dispensing with 10 tool changes therefore results in a gain of 100 minutes. This is offset against a full additional 83 minutes for the monitoring routine, and thus a gain in time of just under 17 minutes, or 17%.

The reference image of the profiled work side of the ultrasonic tool and/or of the profile of the work side used for the comparison can show the work side in any defined and known condition. In particular, in the case of the reference image, emphasis is placed on the new condition of the ultrasonic tool or a limit wear state. Advantageously, the comparison of the actual wear state with the new condition of the ultrasonic tool, in particular, allows reliable and reproducible statements regarding the wear of the ultrasonic tool.

The measures that can be initiated when the limit wear value is reached or exceeded can include, for example, the changing or maintenance of the ultrasonic tool itself. For example, provision can be made that the operating staff or a control center is informed of the need for action.

The actual wear value, and optionally the at least one high-resolution 2D image of the profiled work side of the ultrasonic tool and/or of the profile of the work side in the wear state, can be stored together with further information about the actual wear state and, in particular, the number of joining operations that have already been carried out with the ultrasonic tool at the time of the recording of the at least one high-resolution 2D image. A predicted value for a remaining service life of the ultrasonic tool, for example, can then be determined on the basis of the stored values for one or more wear states of the ultrasonic tool. By means of the calculation of the predicted value, the inspection interval at which the wear is optically determined can potentially be increased in the early phases of the service life of the tool, with the result that the expenditure of time for wear monitoring is reduced and productivity is further improved.

The comparison of the at least one high-resolution 2D image of the profiled work side of the ultrasonic tool and/or of the profile of the work side in the wear state with the reference image of the ultrasonic tool and the determination of the actual wear value can be accomplished by means of cross correlation, edge detection, and/or neural networks. These methods advantageously allow a fast and reliable comparison of the ultrasonic tool in the actual wear state with the reference or original state of the ultrasonic tool.

The rating of progressive wear of various ultrasonic tools by experts can be employed when a neural network is used, and for the purpose of training it. Such a neural network can then be available in a central database for various ultrasonic joining machines. The depth composition can be determined with all three approaches. Height information can likewise be evaluated. Such methods are known from digital microscopes, for example.

A multiplicity of high-resolution 2D images of the profiled work side of the ultrasonic tool and/or of the profile of the work side in an identical wear state can be compared with a multiplicity of reference images of the ultrasonic tool in its reference state. The multiple high-resolution 2D images of the work side in the wear state show the work side from different directions or perspectives in this case. The wear detection is advantageously improved by this means. For example, the multiple high-resolution 2D images can be compared with multiple reference images recorded from the same direction and/or perspective in each case.

For example, the multiple high-resolution 2D images of the work side of the ultrasonic tool can be recorded by one or more cameras that are installed so as to be stationary. The ultrasonic tool is brought into the capture region of the at least one camera for this purpose, and oriented such that the at least one camera can capture the work side of the ultrasonic tool. The kinematics of the ultrasonic joining machine, in particular, can be used to displace the ultrasonic tool and to position and orient the same in the capture region of the one or more cameras that are installed so as to be stationary. For example, such an ultrasonic joining machine has three-axis kinematics for positioning the ultrasonic tool in space and a degree of rotational freedom for rotating the ultrasonic tool about its longitudinal axis. Alternatively or in addition, provision can be made that the camera is installed so as to be displaceable or movable and, for creating the at least one high-resolution 2D image, is oriented with knowledge of the position of the ultrasonic tool such that the ultrasonic tool is arranged in the capture region of the camera.

A single camera can be used in order to create the multiple high-resolution 2D images of the ultrasonic tool. The ultrasonic tool can be displaced into the capture region of the sole camera for this purpose, and repeatedly reoriented there so that the high-resolution 2D images of the profiled work side of the ultrasonic tool are recorded sequentially from different perspectives or directions by means of the one camera. Advantageously, the method for wear detection can be implemented very economically on the hardware side through the use of a single camera.

Images taken at different exposures that are recorded with identical lighting and identical camera position can also be used—individually or after combination to form an image with high dynamic range (HDR)—for image-assisted ascertainment and evaluation of the wear. The different exposure can be achieved through a different exposure time or a different sensitivity of the camera.

Two or more cameras can be provided in order to record the multiplicity of high-resolution 2D images of the profiled work side of the ultrasonic tool and/or of the profile of the work side in the wear state from different directions or perspectives. The multiple high-resolution 2D images can then be recorded simultaneously by the different cameras. As a function of the position of the camera relative to the ultrasonic tool, the high-resolution 2D images thus recorded then show the profiled work side of the ultrasonic tool in the wear state from different directions or perspectives.

The work side of the ultrasonic tool and/or the profile of the work side can be illuminated by means of a lighting unit at the time of the creation of the at least one high-resolution 2D image. The accuracy or reliability of the method according to the invention is advantageously improved by means of the illumination of the work side of the ultrasonic tool.

A defined lighting situation can be created at the profiled work side of the ultrasonic tool and/or the profile of the work side by means of the lighting unit. For example, a striped light pattern or another lighting pattern that is advantageous for wear detection can be created.

In providing a lighting situation, it is important to ensure uniform and reproducible lighting, in particular. In this context, in particular the orientation of the lighting units, their association with the at least one camera, the intensity and polarization of the light, as well as its spectrum and/or its wavelength are important. In particular, the intensity of the light should be chosen such that good illumination of the work side of the ultrasonic tool is achieved and that ambient light has only a negligible effect during the recording of the at least one high-resolution 2D image. Measures for reducing the incident ambient light can also contribute here, for example the switching off or dimming of light sources, in particular automated switching off or dimming, during the recording of the at least one high-resolution 2D image or a shielding of the work side of the ultrasonic tool from ambient light. In this way, high-resolution 2D images of the work side of the ultrasonic tool that are practically independent of the ambient light conditions can be attained successfully.

Optionally, optical elements such as lenses and/or mirrors can be used in addition to the at least one camera and/or the at least one lighting unit in order to create the high-resolution 2D images of the work side of the ultrasonic tool or to optimally illuminate the same.

At least one high-resolution 2D image of the profiled work side of the ultrasonic tool and/or of the profile of the work side in a first wear state and in at least one additional wear state of the ultrasonic tool can be created with a time offset in each case. For example, the wear state of the ultrasonic tool can be captured at regular or irregular time intervals. For example, the wear state of the ultrasonic tool can be captured after a predetermined number of joining operations. For example, the wear state of the ultrasonic tool can be captured in an event-driven manner. In event-driven capture, provision can be made, for example, that a wear state of the ultrasonic tool is ascertained when a deviation, a defective joint, or a critical process condition that may well originate from a worn ultrasonic tool or whose cause is initially unknown is detected by parallel process monitoring of a joining process.

The method according to the invention can be used in the ultrasonic-assisted connection of metallic connection partners. In particular, automatic ultrasonic spot-welding machines and/or ultrasonic wire bonders serve here as ultrasonic joining machines.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1a and 1b show a comparison of a perspective representation of an ultrasonic tool with a profiled work side (a) in an unworn, initial state and (b) in a first wear state,

FIG. 2 is a side view (profile) of the ultrasonic tool from FIG. 1 in the first wear state,

FIGS. 3a to 3d show comparisons of a first and a second side view of the ultrasonic tool with the profiled work side in the initial state and in a second wear state,

FIG. 4 is a schematic diagram of a first measuring arrangement for detecting wear on ultrasonic tools,

FIG. 5 is a schematic diagram of a second measuring arrangement for detecting wear on ultrasonic tools,

FIG. 6 is a schematic diagram of a third measuring arrangement for detecting wear on ultrasonic tools in a first measuring configuration,

FIG. 7 is a schematic diagram of the third measuring arrangement for detecting wear on ultrasonic tools in a second measuring configuration, and

FIG. 8 is a schematic diagram of the third measuring arrangement for detecting wear on ultrasonic tools in a third measuring configuration.

### DETAILED DESCRIPTION

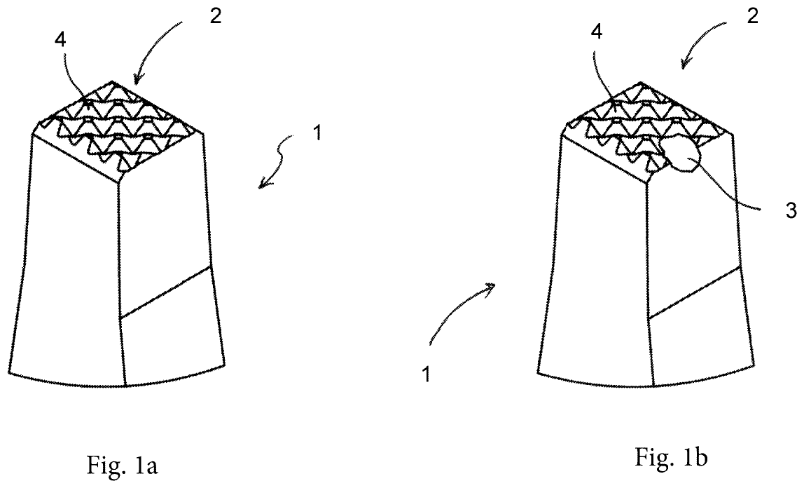

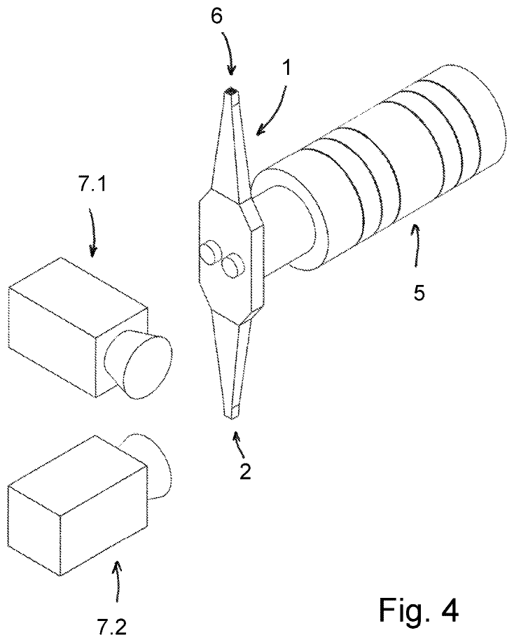

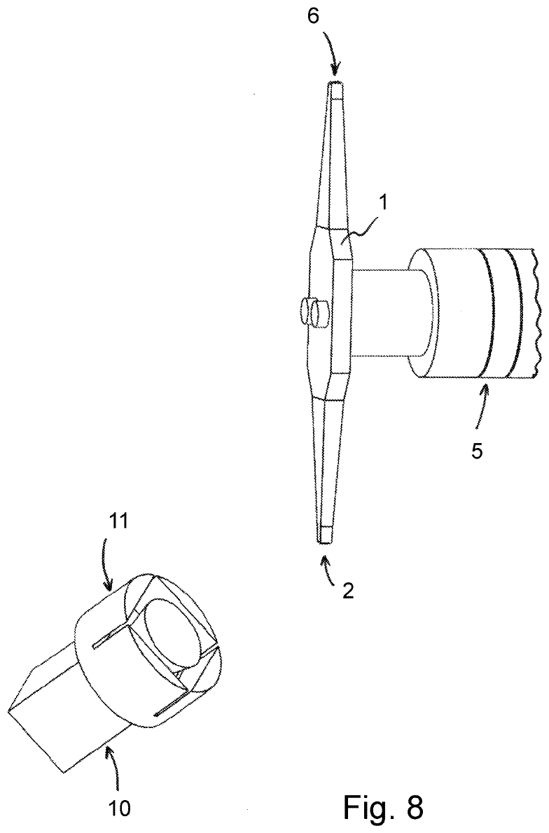

Via the method according to the invention, it is possible to closely inspect a wear state of an ultrasonic tool 1 during the manufacturing process. By way of example, different wear states of the ultrasonic tool are described below on the basis of FIG. 1 to 3. FIG. 4 to 8 then show three measuring arrangements for wear detection on ultrasonic tools.

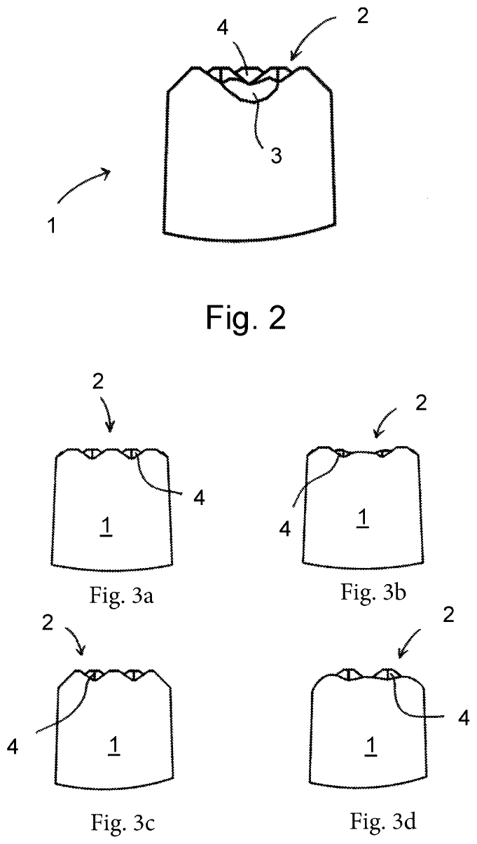

FIG. 1 shows the ultrasonic tool 1 with its profiled work side 2 in an unworn initial state (FIG. 1a) and in a first comparison state (FIG. 1b). In the unworn initial state, the profiled work side 2 provides a multiplicity of pyramidal profiles 4 arranged with a uniform offset from one another. In the first wear state according to FIG. 1b, a chipped spot 3, which necessitates replacement of the ultrasonic tool 1, is then formed laterally on the work side 2. FIG. 2 shows a side view of the ultrasonic tool 1 in the first wear state in profile correlating with the chipped situation from FIG. 1b.

A chipped spot, such as is shown in FIGS. 1b and 2, can be detected by means of optical wear detection within the scope of a regular optical inspection of the profiled work side 2 of the ultrasonic tool 1 equally as well as in an event-driven special inspection. The chip situation can be anticipated in the production process on the basis of an unusually high instantaneous power consumption, for example. The high power consumption can then be used as a trigger in order capture the wear state of the ultrasonic tool 1 in a situational and event-driven manner outside of wear state monitoring that perhaps is time-based or specified on the basis of the number of joining operations.

FIG. 3a to 3d show the ultrasonic tool 1 unworn (FIG. 3a and FIG. 3c) and worn (FIG. 3b and FIG. 3d) in a first side view (FIG. 3a and FIG. 3b) and in a second side view (FIG. 3c and FIG. 3d). The wear situation of the ultrasonic tool 1 on its profiled work side 2 can be discerned in particular by the edge wear of the pyramidal profiles 4 in this case. A comparison of the high-resolution 2D images of the ultrasonic tool 1 with the profiled work side 2 in the wear state according FIGS. 3b and 3d with the reference images (FIGS. 3a and 3c) can accordingly be used to ascertain the actual wear value for the ultrasonic tool 1 by way of image processing and to compare this actual wear value with a tool-specific limit wear value. If the actual wear value reaches or exceeds the limit wear value, then a change of the ultrasonic tool 1 is initiated or the ultrasonic tool 1 is sent for maintenance or refurbishment.

FIG. 4 shows a first measuring arrangement for detecting wear on the ultrasonic tool 1. In the first measuring arrangement, the ultrasonic tool 1, which is designed as a reversible tool, is arranged with its work side 2 in a capture region of a first camera 7.1 and of a second camera 7.2. The cameras 7.1, 7.2 make high-resolution 2D images of two side views of the same ultrasonic tool 1 with the profiled work side 2. The side views are rotated by 90° on account of the orientation of the cameras 7.1, 7.2. For example, the side views according to FIG. 3a to 3d could have been recorded with this first measuring arrangement.

The ultrasonic tool 1 is excited into ultrasonic vibrations by a transducer 5. In the example shown, in addition to the wear-monitored work side 2, the tool provides a further work side 6 that, in the configuration shown, is disengaged and is not used. A wear monitoring of the further work side 6 accordingly is not carried out.

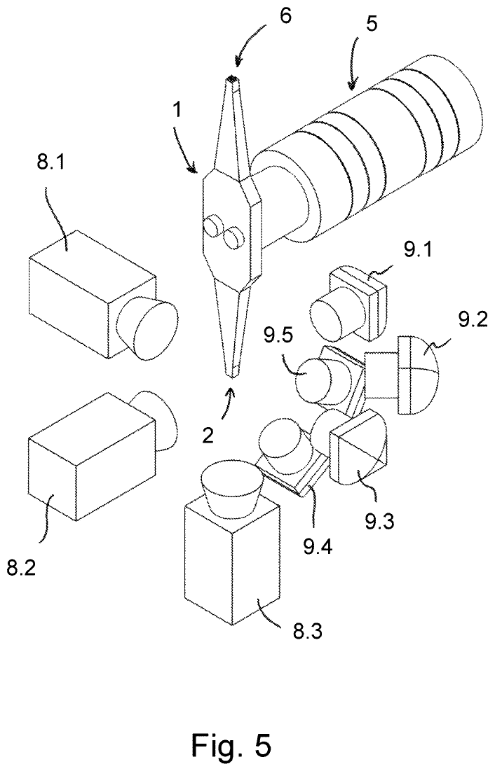

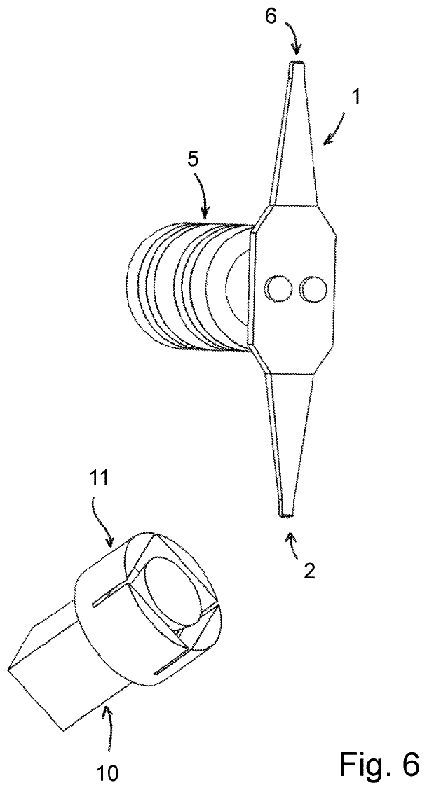

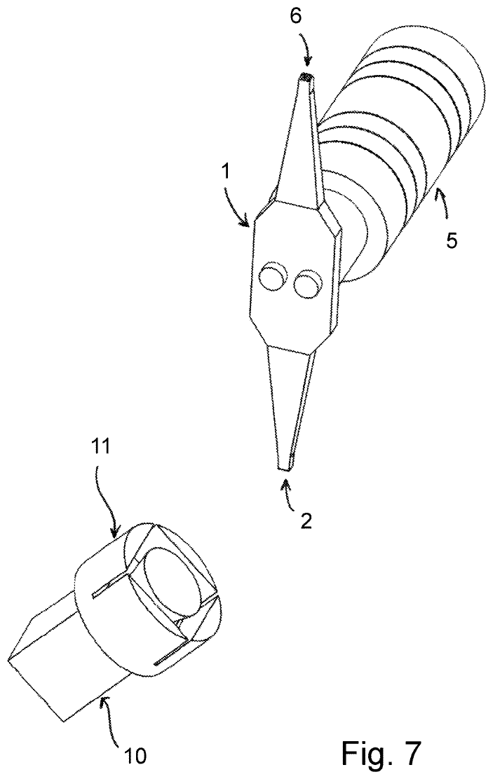

A second measuring arrangement according to FIG. 5 now provides a total of three cameras 8.1, 8.2, 8.3, which are each turned by 90° and view the profiled work side 2 of the ultrasonic tool 1 from different directions. In addition, five lighting units 9.1, 9.2, 9.3, 9.4, 9.5 in all are provided that serve to illuminate the profiled work side 2 of the ultrasonic tool 1 during the recording of the high-resolution 2D images of the work side 2 of the ultrasonic tool 1 by means of the three cameras 8.1, 8.2, 8.3. For example, the profiled work side 2 can be uniformly illuminated by means of the lighting units 9.1, 9.2, 9.3, 9.4, 9.5. Alternatively, a patterned lighting that is advantageous for detecting the wear situation, for example a striped pattern, can be provided by means of all or individual lighting units 9.1, 9.2, 9.3, 9.4, 9.5.

Whereas a multiplicity of high-resolution 2D images of the profiled work side 2 of the ultrasonic tool 1 can be produced simultaneously by means of the first measuring arrangement according to FIG. 4 and the second measuring arrangement according to FIG. 5, a single camera 10 is provided in the third measuring arrangement according to FIG. 6 to 8, which serves to sequentially record multiple high-resolution 2D images of the work side 2 of the ultrasonic tool 1 in an identical wear state. For this purpose, the ultrasonic tool 1 is positioned in the capture region of the single camera 10 by means of displacement kinematics provided by the ultrasonic joining machine. The position of the ultrasonic tool 1 in this case is different every time so that three high-resolution 2D images of the profiled work side 2 of the ultrasonic tool 1 in the same wear state are recorded sequentially by means of the single camera 10 in the present exemplary embodiment of the invention. In order to achieve optimal illumination of the profiled work side 2, the camera 10 provides an annular lighting unit 11 by way of example. Camera 10 and lighting unit 11 are, in particular, installed so as to be stationary.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for detecting wear on an ultrasonic tool, the method comprising:
positioning a displaceable and/or rotatably held ultrasonic tool of an ultrasonic joining machine relative to at least one camera of the ultrasonic joining machine such that a profiled work side of the ultrasonic tool and/or a profile of the work side is provided in a capture region of the at least one camera;
creating at least one high-resolution 2D image of the profiled work side of the ultrasonic tool and/or of the profile of the work side in a wear state by the at least one camera;
comparing the at least one high-resolution 2D image of the profiled work side of the ultrasonic tool and/or of the profile of the work side in the wear state with at least one reference image of the profiled work side of the ultrasonic tool;
ascertaining an actual wear value for the ultrasonic tool via image processing;
comparing the actual wear value of the ultrasonic tool with a tool-specific limit wear value; ad
initiating, if the actual wear value reaches or exceeds the tool-specific limit wear value, measures for changing or for maintenance of the ultrasonic tool.

2. The method according to claim 1, wherein the at least one reference image shows the ultrasonic tool with the profiled work side and/or the profile of the work side in a new condition and/or in a limit wear state.

3. The method according to claim 1, wherein the actual wear value, and optionally the at least one high-resolution 2D image of the profiled work side of the ultrasonic tool and/or of the profile of the work side in the wear state, is/are stored together with further information about the actual wear state, or with a number of joining operations that have already been carried out with the ultrasonic tool.

4. The method according to claim 1, wherein multiple high-resolution 2D images of the profiled work side of the ultrasonic tool and/or of the profile of the work side are created in an identical wear state, and wherein the multiple high-resolution 2D images of the profiled work side of the ultrasonic tool and/or of the profile of the work side in the identical wear state are recorded from different directions and/or perspectives.

5. The method according to claim 1, wherein the at least one camera is installed so as to be stationary and the ultrasonic tool is brought into the capture region of the at least one camera to produce the at least one high-resolution 2D image.

6. The method according to claim 1, wherein the comparison of the at least one high-resolution 2D image of the profiled work side of the ultrasonic tool and/or of the profile of the work side in the wear state with the at least one reference image during the image processing and the determination of the actual wear value are accomplished via cross correlation and/or edge detection and/or neural networks.

7. The method according to claim 1, wherein the profiled work side of the ultrasonic tool and/or the profile of the work side is illuminated via a lighting unit at the time of the creation of the at least one high-resolution 2D image, wherein a light intensity emitted by the lighting unit at the non-shadowed points of the ultrasonic tool located in a camera image exceeds a light intensity of the incident ambient light by at least a factor of 10 or by the factor of 100.

8. The method according to claim 1, wherein the wear state of the work side of the ultrasonic tool and/or of the profile of the work side is captured via a single camera, wherein the single camera sequentially creates multiple 2D images that show the ultrasonic tool with the profiled work side in at least two different orientations.

9. The method according to claim 1, wherein at least one high-resolution 2D image of the profiled work side of the ultrasonic tool and/or of the profile of the work side in a first wear state and in at least one additional wear state of the ultrasonic tool are created with a time offset in each case.

10. The method according to claim 1, wherein a predicted value for a remaining service life of the ultrasonic tool is determined based on an actual wear value and/or stored wear values for the ultrasonic tool and/or based on a number of already-performed joining operations for the ultrasonic tool that is associated with the actual wear value and/or the stored wear values.

11. The method according to claim 1, wherein the wear state of the ultrasonic tool is captured at regular and/or irregular time intervals.

12. The method according to claim 1, wherein the wear state of the ultrasonic tool is captured after a predetermined number of joining operations.

13. The method according to claim 1, wherein the wear state of the ultrasonic tool is captured in an event-driven manner.

14. The method according to claim 1, wherein the method is adapted for ultrasonic-assisted connection of metallic connection partners via an automatic ultrasonic spot-welding machine and/or an ultrasonic wire bonder as an ultrasonic joining machine.
